(19) United States
(12) Patent Application Publication
(10) Pub. No.: US 2009/0235785 A1
(43) Pub. Date: Sep. 24, 2009

(54) GEAR SYSTEM FOR A WRENCH

(76) Inventor: Il-Kwon KIM, Moraga, CA (US)

Correspondence Address: Haynes and Boone, LLP;IP Section, 2323 Victory Avenue, SUITE 700, Dallas, TX, 75219, US

(21) Appl. No.: 12/051,671

(22) Filed: Mar. 19, 2008

(51) Int. Cl. B25B 23/00; B25B 17/00

(52) U.S. Cl. 81/57.33; 81/57

(57) ABSTRACT

A gear mechanism is presented. The gear mechanism includes a structure having a spiral-pattern groove with an axis extending through a center of the spiral-pattern groove and an arm with teeth extending across the spiral-pattern groove. The teeth are shaped and arranged to fit in the spiral-pattern groove such that when the structure is rotated about the axis, the teeth slide in the spiral-pattern groove to move the arm toward or away from the center of the spiral-pattern groove depending on the direction of rotation. This gear mechanism may be incorporated into a wrench, such as a wrench for removing and installing automotive oil filters.

### BACKGROUND

1. Field of Invention

This invention relates generally to a gear system useful for a wrench for grabbing and turning an object.

2. Related Art

Substantially all modern vehicles that incorporate internal combustion engines use lubricating oil that circulates through the engine during operation. These engines use oil filter cartridges for removing dirt and other particles from the lubricating oil, so that the particles do not circulate through the engine undesirably. Draining out the dirty oil and replacing it with new oil, as well as the replacement of the oil filter, is a routine engine maintenance procedure that are performed for these types of vehicles that rely on internal combustion engines. The size of the oil filters vary among the different engines.

Changing the oil filter requires a tool not only because the oil filter can sometimes be hot enough to cause a burn but also because sufficient torque needs to be applied to tighten or loosen the oil filter. One of the tools commonly used to take out and replace the oil filter is a band type oil filter wrench made of a single, thin, circular metal band with a long handle on the side for lateral wrenching drive. However, this oil filter wrench is awkward and inconvenient to use because the oil filter is usually located in a tight, crowded spot of an engine block underneath a vehicle. The limited space around the oil filter makes it challenging to use the long handle band wrench, which has its wrenching axis around the periphery of the oil filter. Due to the space limitation around the oil filter and the slippery surface of the metal band, it is difficult to get a solid grip around the oil filter with the circular metal band wrench. An adjustable, compact, and easy-to-use wrench that can grip/grab an object (e.g., a cylindrical object) securely is desired.

### SUMMARY

In one aspect, the invention is a novel gear mechanism. The gear mechanism includes a structure having a spiral-pattern groove with an axis extending through a center of the spiral-pattern groove. An arm with teeth extends across the spiral-pattern groove. The teeth on the arm are shaped and arranged to fit into the spiral-pattern groove such that when the structure is rotated about the axis, the arm moves toward or away from the center of the spiral-pattern groove depending on the direction of rotation.

In another aspect, the invention is a wrench for grabbing an object. The wrench includes a gear structure having a spiral-pattern groove with an axis extending through a center of the spiral-pattern groove. A plurality of arms are coupled to the structure, wherein each of the arms extends across a part of the spiral-pattern groove and has teeth that fit into the spiral-pattern groove such that when the structure is rotated about the axis, the teeth slide in the spiral-pattern groove to move the arms toward or away from the center of the spiral-pattern groove depending on the direction of rotation.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### DESCRIPTION OF THE DRAWINGS

FIG. 1 is a perspective view of a wrench that incorporates the gear system of the invention.

FIG. 2A is a perspective view of a gear structure having a spiral-pattern groove.

FIG. 2B is a perspective view of a gripping structure that is designed to fit with the gear structure of FIG. 2A.

FIG. 2C is a housing that is designed to couple with the gear structure of FIG. 2A.

FIG. 3A and FIG. 3B are cross-sectional views of the wrench of FIG. 1 with the gripping structure in different positions.

FIG. 4A and FIG. 4B are plan views of the teeth on the gripping structure of FIG. 2B.

FIG. 5A and FIG. 5B are cross-sectional views of the gripping structure engaged with the spiral-pattern groove in different embodiments of the invention.

FIG. 6 is a perspective view of an alternative embodiment of a wrench that incorporates the gear system of the invention.

### DETAILED DESCRIPTION

In the following description, reference is made to the accompanying drawings which illustrate several embodiments of the present invention. It is understood that other embodiments may be utilized and mechanical, compositional, structural, and operational changes may be made without departing from the spirit and scope of the present disclosure. The following detailed description is not to be taken in a limiting sense, and the scope of the embodiments of the present invention is defined only by the claims of the issued patent.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

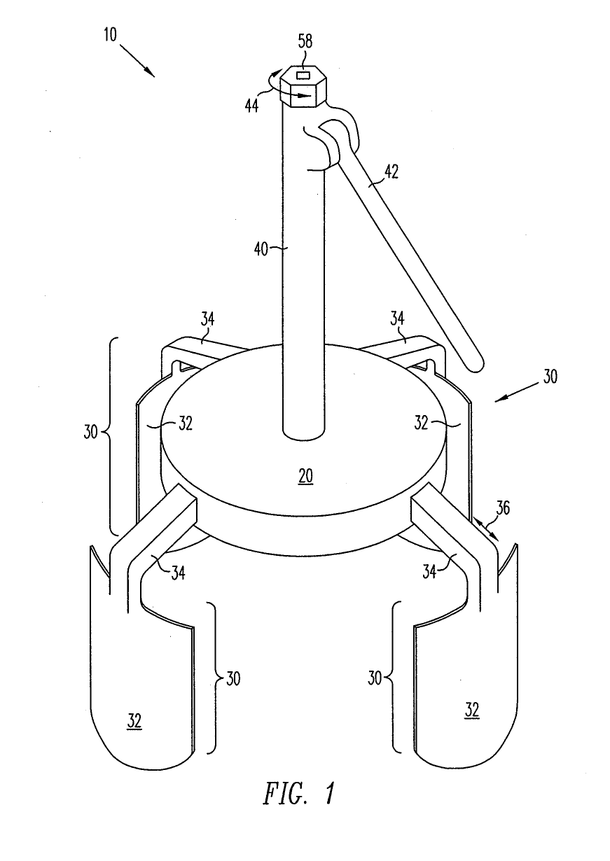

FIG. 1 is a perspective view of a wrench 10 that incorporates the gear system of the invention. The wrench 10 may be used for clamping and opening a cylindrical object, including but not limited to an automotive oil filter. The wrench 10 has a housing 20 that holds the gear mechanism, a gripping structure 30, and a shaft 40 that extends from the housing 20. The shaft 40 is hollow and may extend substantially orthogonally to a surface of the housing 20. Each of the gripping structure 30 has a paddle 32 that contacts and grips the cylindrical object and an arm 34 that connects the paddle 32 to the gear system in the housing 20. The arm 34 moves in and out of the housing 20 as shown by an arrow 36. The positions of the arms 34 depend on the size of the object being gripped—the bigger the object, the farther out the arms 34 will extend from the housing 20.

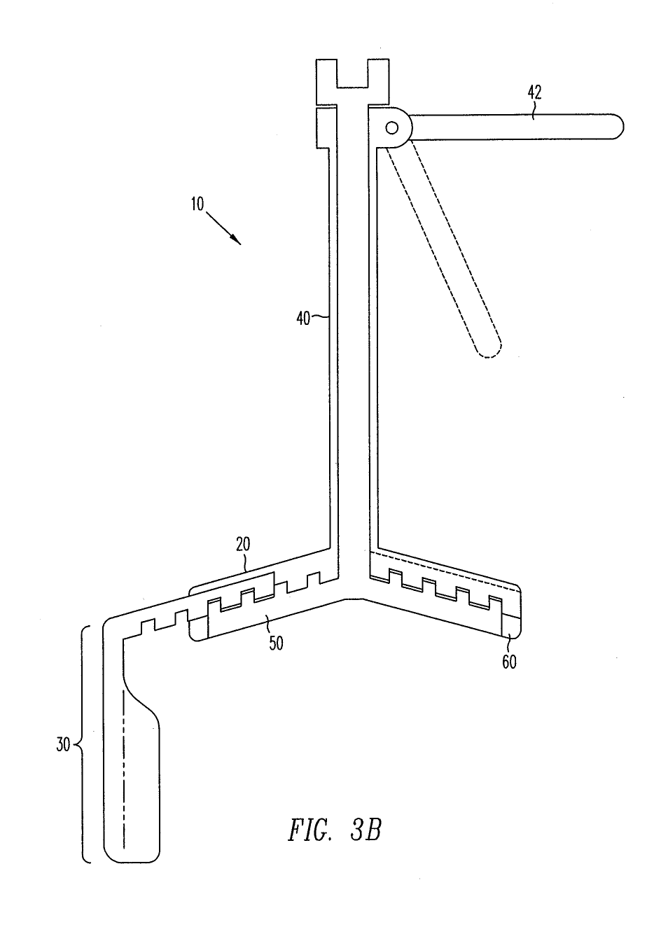

A bolt 58 sits at the top of the shaft 40 and is used to adjust the size of the “grip.” As will be explained below, the bolt 58 can be turned in the directions shown by an arrow 44, for example by using a ratchet (see FIG. 3A below). Turning the bolt 58 turns the gear mechanism that sits in the housing 20, adjusting the positions of the gripping structures 30. By turning the bolt 58, a user widens or tightens the “grip” of the wrench 10 to fit the size of the object that is being gripped. If rotated in one direction of the arrow 44, the gripping structures 30 extend farther out of the housing 20 to grip a wide object. If rotated in the opposite direction of the arrow 44, the gripping structures 30 retract into the housing 20 to tightly grip a smaller object. All (four, in the embodiment shown) the gripping structures 30 move at the same time.

A handle 42 is coupled to the shaft 40 and is useful for turning the wrench 10 to loosen or tighten the gripped object. The handle 42 facilitates a user to turn the entire wrench 10 and apply the necessary torque. Typically, a user would first turn the bolt 58 to tighten the wrench's grip around an object, and then turn the wrench 10 using the handle 42 to turn the gripped object.

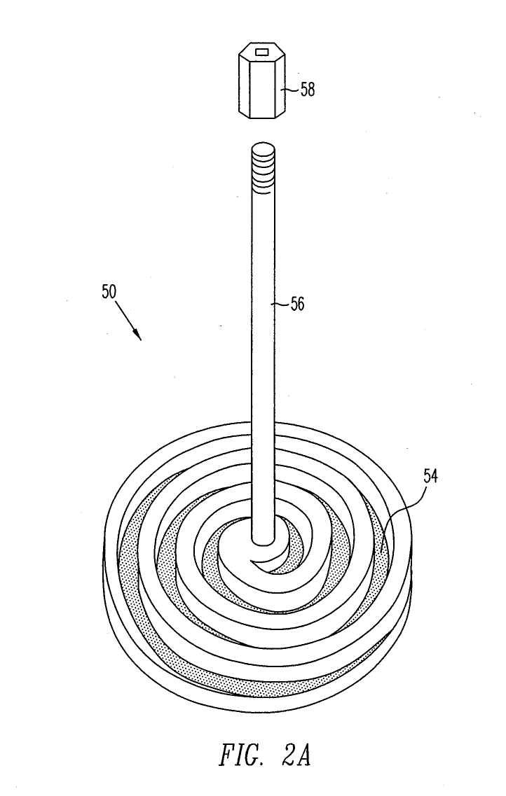

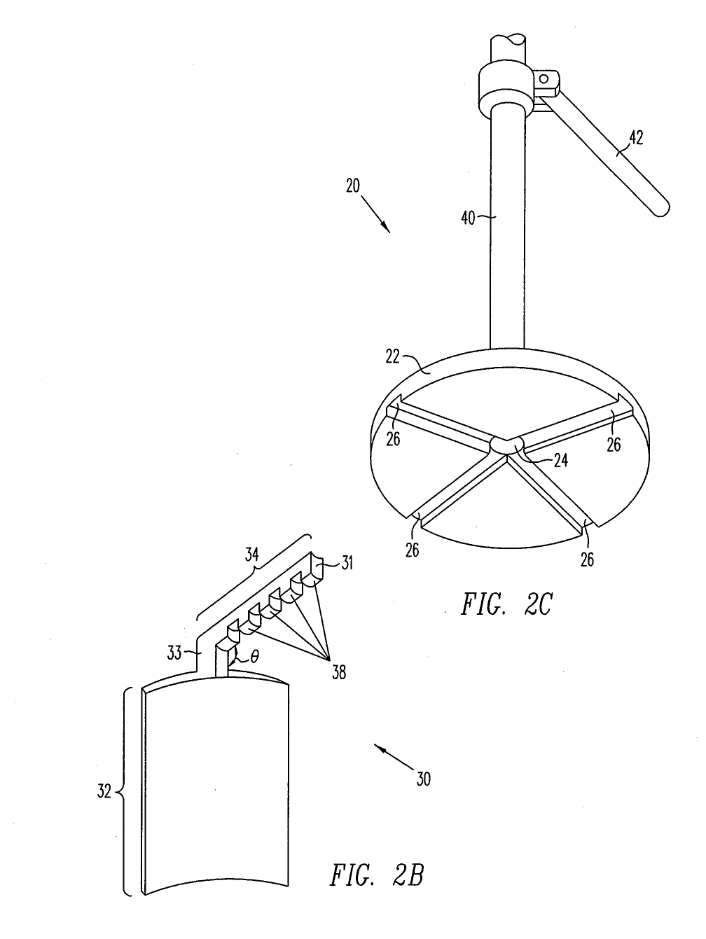

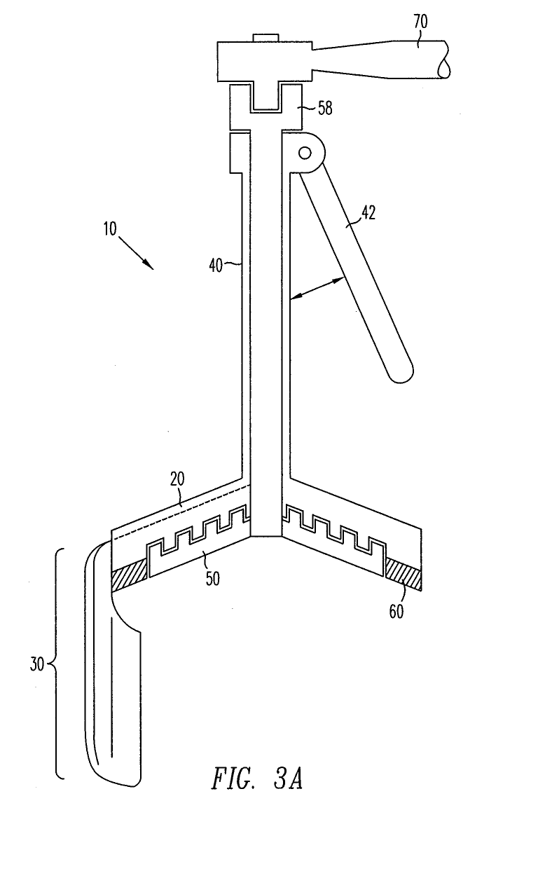

FIGS. 2A, 2B, and 2C show various parts that make up the wrench 10. FIG. 2A shows a gear structure 50 having a spiral-pattern groove 54. The spiral-pattern may be right-hand threaded or left-hand threaded. As shown, a rod 56 extends from the center of the spiral pattern groove 54 orthogonally to the substantially circular plane of the spiral-pattern groove. The rod 56 is designed to fit with a bolt 58 so that turning the bolt 58 would turn the rod 56. When the rod 56 is turned, the spiral-pattern groove 54 turns too. One end of the rod 56 may be threaded for secure coupling with the bolt 58.

FIG. 2B shows the gripping structure 30 that fits with the gear structure 50. As shown, the gripping structure 30 has an arm 34 having a proximal end 31 and a distal end 33, and the paddle 32 coupled to the distal end 33. The arm 34 has one or more teeth 38 formed on it, and the teeth 38 are sized, shaped, and arranged to fit with the spiral-pattern groove 54 of the gear structure 50 such that when the gripping mechanism 30 is combined with the gear structure 50, the teeth 38 are engaged with the spiral pattern groove 54. This way, turning the spiral-pattern groove 54 radially pulls the gripping structure 30 in toward the center of the spiral-pattern or pushes it out in the opposite direction. The teeth 38 “ride” the spiral as it turns, continuously moving onto the outer spirals with larger diameters (when the gripping mechanism is pushed out to accommodate a larger object) or moving onto the smaller inner spirals (when the gripping mechanism is pulled in to accommodate a smaller object). Where the arm 34 has only one tooth, the arm 34 functions in substantially the same manner as the arm 34 with multiple teeth.

The paddle 32 is shown to be attached to form an angle θ with respect to the arm 34. This angle θ may be adjusted to fit the application and the shape of the object to be gripped but is typically between about 80 degrees and 120 degrees for gripping-type application. In the embodiment shown, the arm 34 is long enough to lay approximately halfway across the spiral-pattern groove 54 and still extend out of the housing 20. Hence, the arm 34 is longer than the radius of the spiral-pattern groove 54. In another embodiment, the arm 34 may be shorter than the radius of the spiral-pattern groove 54 such that it does not extend all the way to the center of the spiral-pattern groove 54.

Where multiple gripping mechanisms 30 are employed, all the gripping mechanisms 30 may have substantially the same structure. In some embodiments, positions of the teeth 38 may vary slightly among the gripping mechanisms 30 to accommodate the spiral so that all the gripping mechanisms lie at approximately equal distance from the center of the spiral.

FIG. 2C shows the housing 20 designed to couple with the gear structure 50. The housing 20 has a lid 22 that is designed to cover the spiral-pattern groove 54, and the shaft 40 protrudes from the center of the lid 22. The rod 56 (see FIG. 2A) extends into the shaft 40 through a hole 24 when the housing 20 is combined with the gear structure 50. The lid 22 has radially extending grooves 26 formed on the surface and contacts the spiral-pattern gear 54. These radial grooves 26 are shaped and sized to accommodate the gripping structures 30. Although four equally-spaced radial grooves 26 are shown in FIG. 2C, this is not a limitation of the invention and the location and number of the grooves 26 may be adapted to the desired application. When the wrench 10 is assembled, the gripping structures 30 get sandwiched between the lid 62 and the spiral-pattern groove 54, held in place by the radial grooves 26. When the wrench 10 is assembled and the bolt 58 is turned, the gear structure 50 is turned but not the housing 20. This allows the gripping mechanisms 30 to “ride” the spiral groove 54 to extend farther out or retract.

FIG. 3A is a cross-sectional view of the wrench 10 of FIG. 1 that shows how the gear structure 50, the gripping mechanism 30, and the housing 20 fit together upon assembly. For clarity of illustration, only one gripping structure 30 is shown. The teeth 38 of the gripping structure 30 are engaged with the spiral-pattern groove 54 of the gear structure 50, and the arms 34 are held in place by the radial grooves 26 in the housing 20 (see FIG. 2C). A ratchet 70 may be used to turn the bolt 58, which in turn turns the spiral-pattern groove 54 and moves the gripping structure 30 in/out of the housing 20. A ring 60 may be placed around the outer edge of the lid 22 (e.g., by welding it on the bottom surface of the lid 22 after the arms are in place) to stabilize the gripping mechanism 30 as it slides in and out of the housing 20.

FIG. 3B is a cross-sectional view of the wrench 10 of FIG. 3A with the gripping mechanism 30 extended farther out than in FIG. 3A. FIG. 3B also shows how the position of the handle 42 can be adjusted.

FIG. 3A and FIG. 3B show that the lid 22 and the spiral-pattern groove 54 are not flat but sloped all around downward (with respect to FIG. 3) so that the center of the spiral pattern is higher than the edge. The spiral-pattern groove may be described as being formed on an outer surface of a cone with the vertex portion cut off so that there is no pointy portion. The slope of the cone is not a limitation of the invention but may be formed to optimize the functioning of the gear structure 50 in pulling in and pushing out the gripping structures 30. This slope may also be adjusted to best accommodate the shape of the object being gripped.

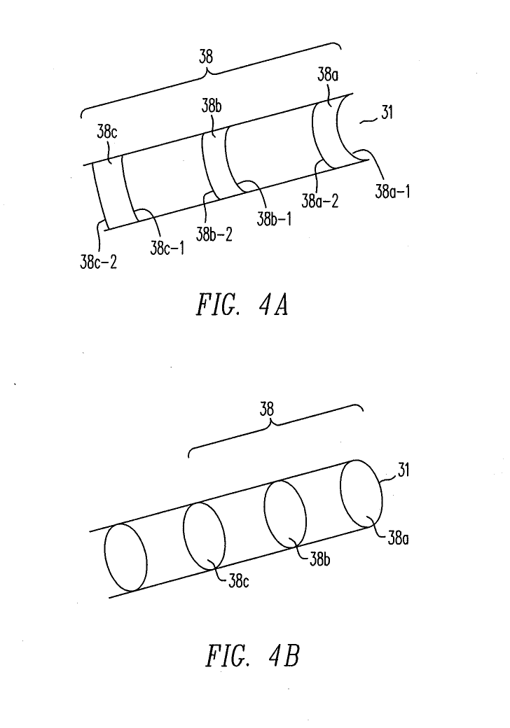

The curvature of the spiral in the spiral-pattern groove 54 changes with its distance from the center. To help the teeth 38 engage securely with the spiral-pattern groove 54 regardless of the position of the arm 34 on the spiral-pattern groove 54, the teeth 38 are designed to accommodate different curvatures. FIG. 4A is a plan view of the teeth 38 showing how each tooth has two different curvatures and how the curvatures vary between teeth 38. For simplicity of illustration, the particular view shows three teeth: a first tooth 38a, a second tooth 38b, and a third tooth 38c. In this embodiment, each tooth has a concave surface and a convex surface, and the concave surface is closer to the proximal end 31. The concave surface 38a-1 of the first tooth 38a is curved more drastically than the convex surface 38a-2. The concave surface 38b-1 of the second tooth 38b is curved less than the convex surface 38a-2 of the first tooth 38a, and the convex surface 38b-2 of the second tooth 38b is curved even less than the concave surface 38b-1. The surface of the tooth that is farther away from the proximal end 31 has less of a curvature. This way, regardless of whether the curvature of the engaging spiral-pattern groove 54 is large or small, the teeth 38 will engage with the groove 54 securely.

FIG. 4B shows another embodiment of the arm 34. Unlike the embodiment shown in FIG. 4A, each tooth has two convex surfaces in this embodiment. The curvatures of the convex surfaces may be varied with distance from the proximal end 31. Each tooth 38a, 38b, 38c may have the same curvature for both surfaces or different curvatures.

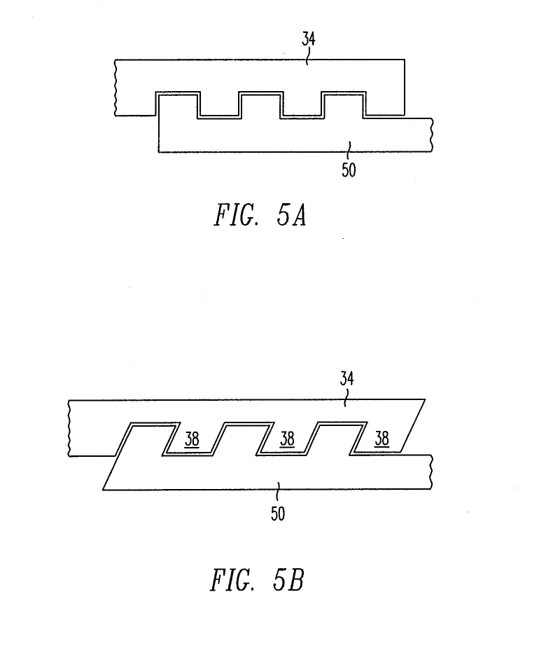

FIG. 5A and FIG. 5B are cross-sectional views of the arm 34 of the gripping structure 30 engaged with the spiral groove 54 of the gear structure 50. In the embodiment of FIG. 5A, the spiral-pattern groove 54 is formed so that the sidewalls of the groove form an approximately 90-degree angle with respect to the bottom of the groove. In this case, the teeth 38 of the arm 34 are formed to fit well with such spiral design. In the embodiment of FIG. 5B, however, the sidewalls of the groove in the spiral pattern are slanted or angled. As mentioned above, the spiral pattern may be sloped all around so that the center of the spiral pattern is higher than the edge of the pattern. In this case, having slanted grooves as in FIG. 5B will help the teeth 38 engage more securely with the gear structure 50 by increasing the pulling force between the teeth 38 and the sidewall of the groove. The teeth 38 are shaped with a slant as well, to fit with the slanted groove design.

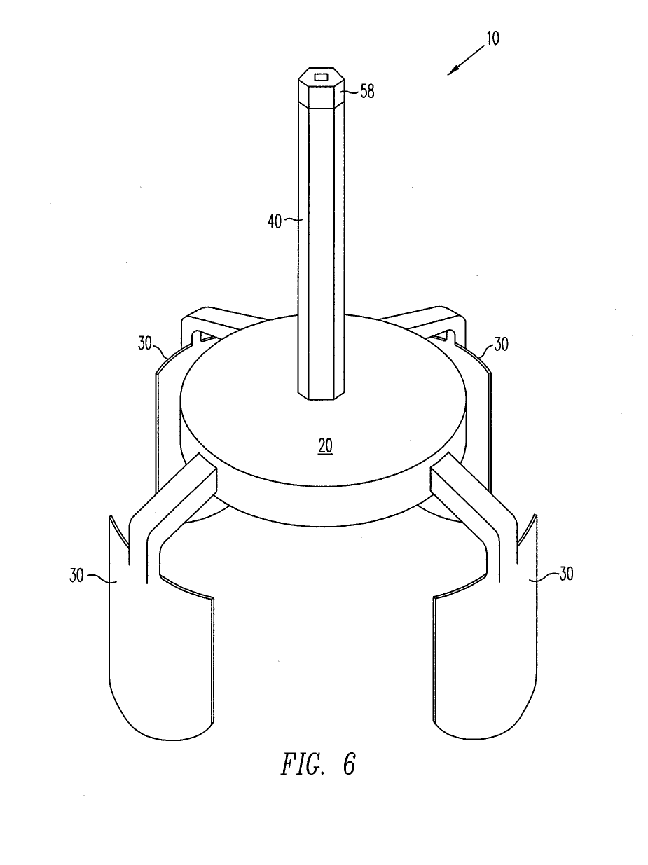

FIG. 6 shows an alternative embodiment for the wrench 10. Unlike the embodiment of FIG. 1, which provides a handle 42 for turning the wrench 10, the embodiment of FIG. 6 has a shaft 40 with a polygonal outer shape. With this embodiment, the wrench 10 would be turned with a wrench. Although the particular shaft 40 shown in FIG. 6 has a hexagonal outer cross-sectional shape, this is not a limitation of the invention.

While the invention has been described in terms of particular embodiments and illustrative figures, those of ordinary skill in the art will recognize that the invention is not limited to the embodiments or figures described. Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A gear mechanism comprising:
a structure having a spiral-pattern groove with an axis extending through a center of the spiral-pattern groove;
an arm with teeth extending across the spiral-pattern groove, wherein the teeth are shaped and arranged to fit in the spiral-pattern groove such that when the structure is rotated about the axis, the teeth slide in the spiral-pattern groove to move the arm toward or away from the center of the spiral-pattern groove depending on the direction of rotation.

2. The gear mechanism of claim 1, wherein the spiral-pattern groove has a circular cross section.

3. The gear mechanism of claim 2, wherein the spiral-pattern groove is sloped in the shape of a cone having the spiral-pattern groove on its outer surface.

4. The gear mechanism of claim 2 further comprising a rod extending through the center of the spiral-pattern groove substantially orthogonally to the plane of the spiral-pattern groove, wherein turning the rod turns the spiral-pattern groove about the axis.

5. The gear mechanism of claim 1, wherein the arm has a proximal end that is closest to the center of the spiral pattern and a distal end that is farthest from the center of the spiral pattern, further comprising a paddle coupled to the distal end.

6. The gear mechanism of claim 5, wherein the paddle extends at an angle θ relative to the arm, wherein 80°<θ<120°.

7. The gear mechanism of claim 1, wherein the arm is a first arm, further comprising a second arm that is substantially the same as the first arm.

8. The gear mechanism of claim 1, wherein the arm is a first arm with a first set of teeth, further comprising a second arm with a second set of teeth positioned differently from the first set of teeth.

9. The gear mechanism of claim 1, wherein the length of the arm is greater than the radius of the spiral-pattern groove.

10. The gear mechanism of claim 1, wherein the teeth have a first surface and a second surface having different curvatures.

11. The gear mechanism of claim 1, wherein the arm extends about halfway across the spiral-pattern groove.

12. The gear mechanism of claim 1, wherein the spiral-pattern groove has sidewalls that are slanted with respect to a bottom surface of the groove and the teeth on the arm are slanted to fit with the slanted groove.

13. A wrench for grabbing an object, the wrench comprising:
a gear structure having a spiral-pattern groove with an axis extending through a center of the spiral-pattern groove;
a plurality of arms coupled to the structure, wherein each of the arms extends across a part of the spiral-pattern groove and has teeth that fit in the spiral-pattern groove such that when the structure is rotated about the axis, the teeth slide in the spiral-pattern groove to move the arms toward or away from the center of the spiral-pattern groove depending on the direction of rotation.

14. The wrench of claim 13 further comprising a housing enclosing the spiral-pattern groove such that the arms are between the housing and the gear structure, the housing having openings through which distal ends of the arms extend out of the housing.

15. The wrench of claim 14, wherein the housing has a first surface that contacts the spiral-pattern groove and radial grooves are formed on the first surface to accommodate the arms and fix the positions of the arms relative to one another.

16. The wrench of claim 13, wherein the structure and the housing have circular cross sections.

17. The wrench of claim 13, wherein the spiral-pattern groove is sloped in the shape of a cone having the spiral-pattern groove on its outer surface.

18. The wrench of claim 14 further comprising a rod coupled to the center of the spiral-pattern groove and a hollow shaft coupled to the center of the housing, wherein the rod extends into the hollow shaft.

19. The wrench of claim 18 further comprising a bolt coupled to an end of the rod that is opposite the end coupled to the spiral-pattern groove, wherein turning the bolt turns the rod in the hollow shaft, thereby turning the spiral-pattern groove.

20. The wrench of claim 18, wherein turning the hollow shaft turns the wrench.

21. The wrench of claim 13, wherein each of the arms has a proximal end that is closest to the center of the spiral pattern and a distal end that is farthest from the center of the spiral pattern, further comprising a paddle coupled to the distal end.

22. The gear mechanism of claim 13, wherein the length of each of the arms is greater than the radius of the spiral-pattern groove.

23. The gear mechanism of claim 13, wherein each of the arms is shorter than the radius of the spiral-pattern groove.

24. The gear mechanism of claim 12, wherein the teeth have a first surface and a second surface having different curvatures.
